(19) United States
(12) Patent Application Publication
(10) Pub. No.: US 2012/0219148 A1
(43) Pub. Date: Aug. 30, 2012

(54) ENCRYPTION/DECRYPTION METHODS, AND DEVICES AND SYSTEMS USING THE SAME

(75) Inventors: Sung-Geun Park, Suwon-si (KR); Gae-Won Seo, Goyang-si (KR)

(73) Assignee: SAMSUNG ELECTRONICS CO., LTD., Suwon-si (US)

(21) Appl. No.: 13/403,281

(22) Filed: Feb. 23, 2012

(30) Foreign Application Priority Data
Feb. 24, 2011 (KR) 10-2011-0016258

(51) Int. Cl. H04L 9/28

(52) U.S. Cl. 380/28

(57) ABSTRACT

An encryption/decryption device includes a control unit, an encryption/decryption unit and a verification unit. The control unit generates a start text and an encryption/decryption control signal in response to a command signal and one of an input text and an inner text according to an operational mode. The encryption/decryption unit encrypts or decrypts the start text to generate a result text in response to the encryption/decryption control signal. The verification unit provides the result text to the control unit as the inner text and generates an output text and an alarm signal based on the result text and the input text according to the operational mode, where the output text is an encrypted version of the input text or a decrypted version of the input text, and the alarm signal indicates the integrity of the output text.

### CROSS-REFERENCE TO RELATED APPLICATION

This application claims priority under 35 USC §119 to Korean Patent Application No. 10-2011-0016258, filed on Feb. 24, 2011 in the Korean Intellectual Property Office (KIPO), the contents of which are herein incorporated by reference in their entirety.

### BACKGROUND

1. Technical Field

Exemplary embodiments relate to encryption/decryption devices and methods, and more particularly, to an encryption/decryption device and method that is able to assess the integrity of encrypted or decrypted output data.

2. Description of the Related Art

Electronic systems may include an encryption/decryption device for encrypting data before storing data or transferring data to another system. However, some encryption/decryption devices may be susceptible to errors which may be induced by an interruption in an encryption/decryption process. Interruptions may occur, for example, as a result of sabotage by a hacker or other intruder. A separate device may be employed to detect such an interruption or attack.

### SUMMARY

Exemplary embodiments in accordance with principles of inventive concepts are directed to provide an encryption/decryption device that is able to determine the accuracy (also referred to herein as determining the integrity) of an output text.

Some exemplary embodiments are directed to provide a system including an encryption/decryption device in accordance with principles of inventive concepts.

According to exemplary embodiments, an encryption/decryption device includes a control unit, an encryption/decryption unit and a verification unit. The control unit generates a start text and an encryption/decryption control signal in response to a command signal and one of an input text and an inner text according to an operational mode. The encryption/decryption unit encrypts or decrypts the start text to generate a result text in response to the encryption/decryption control signal. The verification unit provides the result text to the control unit as the inner text and generates an output text and an alarm signal based on the result text and the input text according to the operational mode, where the output text is an encrypted version of the input text or a decrypted version of the input text, and the alarm signal represents an integrity of the output text. Encrypted or decrypted text may also be referred to herein, simply, as resultant text.

In exemplary embodiments, the verification unit may generate the output text in a first operational mode, and generate the alarm signal by verifying the integrity of the output text in a second operational mode.

The control unit may generate a first start text and a first encryption/decryption control signal in response to the command signal and the input text in the first operational mode, and generate a second start text and a second encryption/decryption control signal in response to the command signal and the inner text in the second operational mode.

The control unit may output the input text as the first start text in the first operational mode, and output the inner text as the second start text in the second operational mode.

The second encryption/decryption control signal may be an inverted version of the first encryption/decryption control signal.

The control unit may include a first buffer configured to receive the input text and output the input text as a first start text in the first operational mode, and configured to receive the inner text and output the inner text as a second start text in the second operational mode, a second buffer configured to receive the command signal in the first operational mode, and configured to output the command signal as a first encryption/decryption control signal in the first operational mode and in the second operational mode, an inverter configured to invert the first encryption/decryption control signal to generate a second encryption/decryption control signal, a control circuit configured to generate an inner control signal having a first logic level when the input text is received, and configured to generate the inner control signal having a second logic level when the inner text is received, and a multiplexer configured to output one of the first encryption/decryption control signal and the second encryption/decryption control signal in response to a logic level of the inner control signal.

The encryption/decryption unit may either encrypt the start text to generate a first result text in the first operational mode and decrypt the start text to generate a second result text in the second operational mode, or decrypt the start text to generate the first result text in the first operational mode and encrypt the start text to generate the second result text in the second operational mode, in response to a logic level of the encryption/decryption control signal.

The verification unit may generate the output text and output the output text in the first operational mode, and generate the alarm in signal and output the alarm signal in the second operational mode.

The verification unit may receive the input text, store the input text as an original text, output the result text received from the encryption/decryption unit as the output text, and provide the result text to the control unit as the inner text in the first operational mode, and store the result text as a comparison text, generate the alarm signal by comparing the original text with the comparison text, and output the alarm signal in the second operational mode.

The verification unit may include a control circuit configured to receive the input text, output the input text as an original text, output the result text received from the encryption/decryption unit as the output text, and provide the result text to the control unit as the inner text in the first operational mode, and configured to output the result text as a comparison text in the second operational mode, a first buffer configured to store the original text received from the control circuit, a second buffer configured to store the comparison text received from the control circuit, and a comparator configured to generate the alarm signal based on whether the comparison text stored in the second buffer is equal to the original text stored in the first buffer.

The verification unit may generate the output text and store the output text in the first operational mode, and generate the alarm signal, output the alarm signal, and selectively output the output text in response to a logic level of the alarm signal in the second operational mode.

The verification unit may receive the input text, store the input text as an original text, store the result text received from the encryption/decryption unit as the output text, and provide the result text to the control unit as the inner text in the first operational mode, and store the result text as a comparison text, generate the alarm signal by comparing the original text with the comparison text, output the alarm signal, and selectively output the output text in response to a logic level of the alarm signal in the second operational mode.

The verification unit may include a control circuit configured to receive the input text, output the input text as an original text, output the result text received from the encryption/decryption unit as the output text, and provide the result text to the control unit as the inner text in the first operational mode, and configured to output the result text as a comparison text in the second operational mode, a first buffer configured to store the original text received from the control circuit, a second buffer configured to store the comparison text received from the control circuit, a third buffer configured to store the output text received from the control circuit, a comparator configured to generate the alarm signal based on whether the comparison text stored in the second buffer is equal to the original text stored in the first buffer, and a switch configured to selectively output the output text stored in the third buffer in response to a logic level of the alarm signal.

According to exemplary embodiments, a system includes an encryption/decryption device and a processor. The encryption/decryption device generates an output text by encrypting or decrypting an input text in response to a command signal and generates an alarm signal representing an integrity of the output text. The processor controls the encryption/decryption device by providing the input text and the command signal to the encryption/decryption device. The encryption/decryption device includes a control unit configured to generate a start text and an encryption/decryption control signal in response to the command signal and one of the input text and an inner text according to an operational mode, an encryption/decryption unit configured to encrypt or decrypt the start text to generate a result text in response to the encryption/decryption control signal, and a verification unit configured to provide the result text to the control unit as the inner text and generate the output text and the alarm signal based on the result text and the input text according to the operational mode.

In exemplary embodiments, the processor may stop an operation of the encryption/decryption device based on the alarm signal.

In exemplary embodiments a method of operating an encryption/decryption device in accordance with principles of inventive concepts cryptographically processes (e.g., encrypts or decrypts) data from a first source to produce output data; inverse-cryptographically process data from a second source to produce comparison data, wherein input data from a second data is output data from the cryptographic process; compares input data to comparison data; and sets the value of an alarm based on the results of the comparison.

In another aspect of a method in accordance with inventive concepts, the cryptographic process may be an encryption or decryption process and the inverse-cryptographic process may be, respectively, a decryption or encryption process.

In another aspect of a method in accordance with principles of inventive concepts, output data is transmitted external to the encryption/decryption device, regardless of the results of the comparison.

In another aspect of a method in accordance with principles of inventive concepts, output data is transmitted outside the encryption/decryption device, only if the comparison indicates that input data and comparison data are the same.

### BRIEF DESCRIPTION OF THE DRAWINGS

Illustrative, non-limiting exemplary embodiments will be more clearly understood from the following detailed description in conjunction with the accompanying drawings.

FIG. 1 is a block diagram illustrating an exemplary embodiment of an encryption/decryption device in accordance with principles of inventive concepts.

FIG. 2 is a block diagram illustrating an exemplary embodiment of a control unit such as may be included in an encryption/decryption device of FIG. 1 in accordance with principles of inventive concepts.

FIG. 3 is a block diagram illustrating an exemplary embodiment of a verification unit such as may be included in an encryption/decryption device of FIG. 1 in accordance with principles of inventive concepts.

FIG. 4 is a flow chart for describing an exemplary embodiment of an encrypting operation of an encryption/decryption device of FIG. 1 in accordance with principles of inventive concepts.

FIG. 5 is a flow chart for describing an exemplary embodiment of a decrypting operation of an encryption/decryption device of FIG. 1 in accordance with principles of inventive concepts.

FIG. 6 is a block diagram illustrating an exemplary embodiment of a verification unit included in an encryption/decryption device of FIG. 1 in accordance with principles of inventive concepts.

FIG. 7 is a flow chart for describing an exemplary embodiment of an encrypting operation of an encryption/decryption device of FIG. 1 in accordance with principles of inventive concepts.

FIG. 8 is a flow chart for describing an exemplary embodiment of a decrypting operation of an encryption/decryption device of FIG. 1 in accordance with principles of inventive concepts.

FIG. 9 is a block diagram illustrating an exemplary embodiment of a system in accordance with principles of inventive concepts.

### DETAILED DESCRIPTION OF THE EMBODIMENTS

The terminology used herein is for the purpose of describing particular embodiments and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

Although claimed subject matter will be described in terms of certain embodiments, other embodiments, including embodiments that do not provide all of the benefits and features set forth herein, are also within the scope of this invention. Various structural, logical, and process step changes may be made without departing from the spirit or scope of the invention. Flow charts may include steps that may be deleted or otherwise modified and the sequence set forth within a particular flow chart may be modified while keeping within the scope of the invention. Signals may be “Positive Logic” (e.g., a logic “1” activates a signal) or “Negative Logic” (e.g., a logic “1” deactivates a signal). Accordingly, the scope of the invention is defined only by reference to the appended claims.

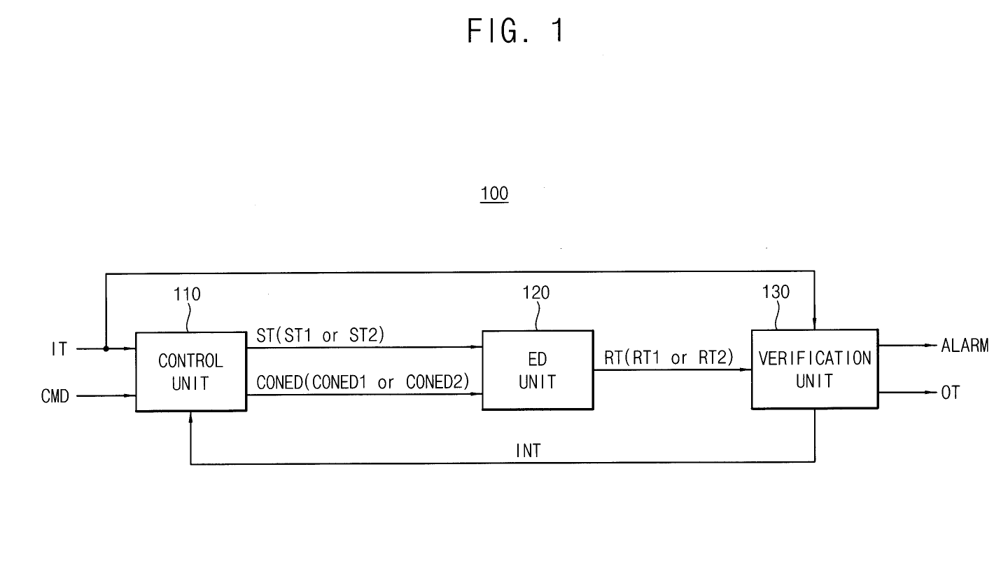

An encryption/decryption device in accordance with inventive principles is depicted in the block diagram of FIG. 1. An exemplary encryption/decryption device 100 in accordance with inventive principles includes a control unit 110, an encryption/decryption unit 120 and a verification unit 130.

In operation, control unit 110 may receive a command signal CMD and an input text IT from an external device, and an “inner text” signal INT from verification unit 130. Although, for convenience, the term “text” may be employed in this disclosure to describe information, or data, sent to and output from encryption/decryption device 100, “text” is not limited to textual information and may be any form of information, including, textual, numerical, visual, or symbolic: any type of information, for example, that may be stored in a computer. Inner text, which will be described in greater detail below, may be provided to control unit 110 by verification unit 130. Control unit 110 may generate a start text ST output and an encryption/decryption control signal CONED in response to inputs, ST, CMD, and INT, and according to operational modes, as will be described in greater detail below.

Encryption-decryption unit 120 receives start text ST and the encryption/decryption control signal CONED from the control unit 110. The CONED control signal determines whether the encryption/decryption unit 120 encrypts or decrypts start text ST to generate a result text RT. CONED may be implemented with positive or negative logic. That is, in one scenario, a logic “HIGH” will cause encryption/decryption unit to encrypt and a logic “LOW” will cause encryption/decryption unit 120 to decrypt and, in another scenario a logic “HIGH” will cause encryption/decryption unit 120 to decrypt and a logic “LOW” will cause encryption/decryption unit 120 to encrypt.

Verification unit 130 receives input text IT from an external device and result text RT from the encryption/decryption unit 120 and operates on these inputs to produce an alarm output ALARM, output text OT, and inner text INT, as will be described in greater detail below. Output text OT is an encrypted or decrypted version of input text IT, alarm signal ALARM provides an indication of the integrity (that is, whether OT includes encryption/decryption errors) of the output text OT, and inner text is merely result text RT, passed from encryption/decryption unit 120 to control unit 110.

In accordance with inventive principles, verification unit may generate an enabled, or active, ALARM signal, which may be an active HIGH or LOW signal, when it determines that output text OT lacks integrity (that is, it includes one or more encryption or decryption errors), or a disabled, or inactive, ALARM signal, which may be an active HIGH or LOW signal, when it determines that output text OT has integrity (that is, it includes no encryption or decryption errors).

In accordance with principles of inventive concepts, encryption/decryption device 100 may operate in a plurality of modes. In exemplary embodiments two modes may be referred to herein as a first, or operational, mode and a second, or verification, mode, for example.

In exemplary embodiments in accordance with principles of inventive concepts, in a first, operational, mode of operation control unit 110 may transmit text received from another device (i.e., ST1=IT), along with a command received from another device (i.e., CONED1=CMD) to ED unit 120. ED unit 120 operates on the received text according to the received command to produce an operational output (RT1=IT*CMD). That is, ED unit 120 produces an encrypted or decrypted version of received text, according to whether the input command was, respectively, encrypt or decrypt. Verification unit 130 may provide the operational output to external circuitry at this point. In exemplary embodiments, verification unit 130 may also activate or deactivate ALARM signal and pass the operational text to control unit 110 (INT=RT1).

In exemplary embodiments in accordance with principles of inventive concepts, in a second, verification, mode of operation, control unit 110 may transmit operational text received from verification unit 130 (ST2=INT), along with the inverse of a command received from another device (CONED2= C̅M̅D̅) to ED unit 120. ED unit 120 operates on the operational text according to the inverse of the received command CMD to produce a comparison text output. That is, ED unit 120 produces an encrypted or decrypted version of received text, according to whether the original, input, command was, respectively, decrypt or encrypt. Verification unit 130 may compare the operational text to the comparison text and provide the operational output text to external circuitry and disable ALARM signal, if the operational text has integrity (that is, is properly encrypted or decrypted) or, simply, enable ALARM, if operational text lacks integrity. In exemplary embodiments, verification unit 130 may also activate or deactivate ALARM signal and pass the operational text to control unit 110.

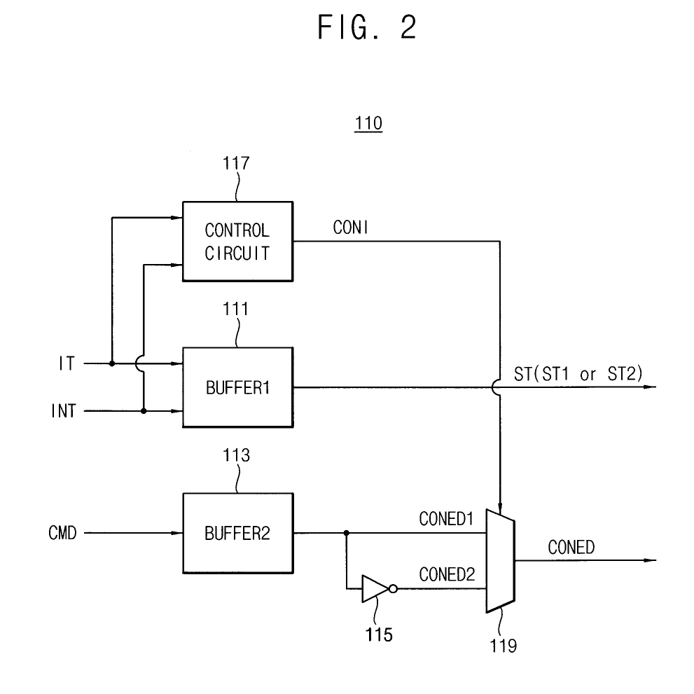

In an exemplary embodiment in accordance with inventive concepts, a control unit 110 may include functional elements as depicted in the block diagram of FIG. 2. In this exemplary embodiment, control unit 110 may include a first buffer 111, a second buffer 113, an inverter 115, a control circuit 117 and a multiplexer 119. First buffer 111 may receive input text IT from an external device, store input text IT, and provide input text IT to encryption/decryption unit 120 as first start text ST1 in a first operational mode, also referred to herein as “operational mode.” First buffer 111 may receive inner text INT from verification unit 130, store inner text INT, and provide inner text INT to encryption/decryption unit 120 as the second start text ST2 in a second operational mode, also referred to herein as “verification mode.”

Second buffer 113 may receive command signal CMD from an external device and store command signal CMD in a first operational mode. Second buffer 113 may output command signal CMD as first encryption/decryption control signal CONED1 and inverter 115 may invert control signal CONED1 to produce control signal CONED2. Control signals CONED1 and CONED2 are both routed to inputs of multiplexer 119, which operates under control of control circuit 117 to select between CONED1 and CONED2 to send to ED Unit 120, as previously described.

In an exemplary embodiment in accordance with inventive concepts, control circuit 117 may receive input text IT from an external device and inner text INT from verification unit 130 and generate an inner control signal CONI based on the input text IT and the inner text INT. In exemplary embodiments, the value of CON1 (that is, active or inactive, high or low, enabled or disabled, etc.) may be determined by which text, IT or INT, is received at control circuit 117, with CON1 reflecting a first operational mode when IT is received and a second operational mode when INT is received. Control signal CON1 may thereby control multiplexer to select CONED1 when in a first operational mode (when BUFFER1 receives text IT) and CONED2 when in a second operational mode (when BUFFER1 receives text INT) as output CONED.

In exemplary embodiments in accordance with inventive concepts, encryption/decryption unit 120 may meet an advanced encryption standard (AED) or a data encryption standard (DES). That is, the encryption/decryption unit 120 may perform an encrypting operation and a decrypting operation using algorithms of an advanced encryption standard (AED) or algorithms of a data encryption standard (DES). Use of other encryption algorithms is contemplated within the scope of inventive concepts.

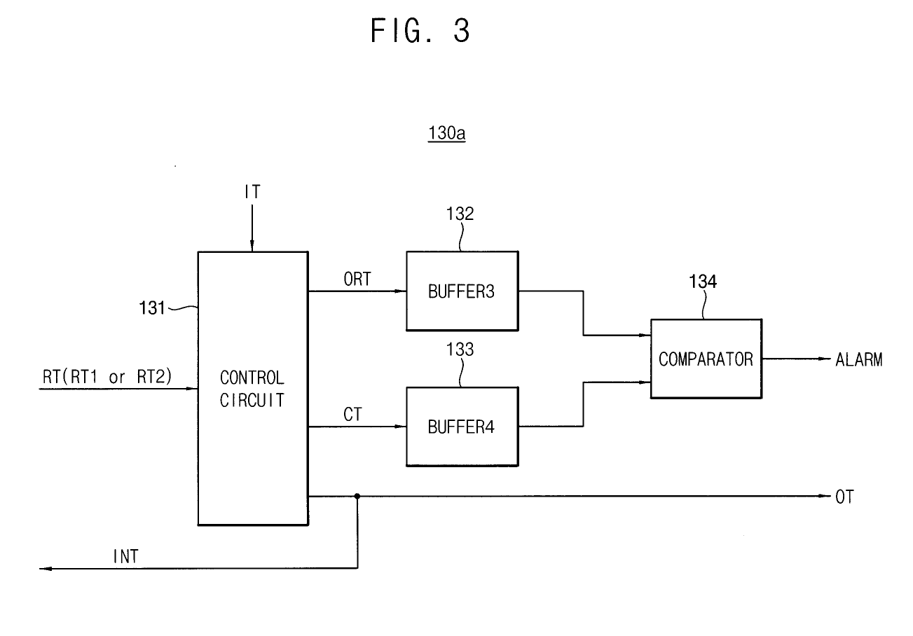

An exemplary embodiment of a verification unit in accordance with inventive concepts is depicted in the block diagram of FIG. 3. Verification unit 130a may sequentially generate and output, first, RT1, in a first operational mode, and, second, a value for alarm signal ALARM, in a second operational mode. Using such a sequential approach may avoid unnecessary processing delays. For example, an encryption or decryption operation may be performed and the results output to another device without delay, then the integrity of the output may be determined and an integrity signal (e.g., ALARM), which may require little time to transmit, may be output to the other device.

In an exemplary embodiment in accordance with inventive concepts, verification unit 130a may include a control circuit 131, a third buffer 132, a fourth buffer 133 and a comparator 134. Control circuit 131 may receive input text IT from an external device and provide input text IT to third buffer 132 as an original text ORT in a first operational mode. In addition, control circuit 131 may receive first result text RT1 from encryption/decryption unit 120, output the first result text RT1 as the output text OT, and provide first result text RT1 to the control unit 110 as inner text INT in a first operational mode. Control circuit 131 may receive second result text RT2 from encryption/decryption unit 120 and provide second result text RT2 to fourth buffer 133 as a comparison text CT in a second operational mode.

As described above, input text IT may be provided from an external device in a first operational mode. Control circuit 131 may therefore determine the operational mode of device 100, based on whether input text IT is received from an external device or not. Third buffer 132 may store original text ORT received from control circuit 131 and fourth buffer 133 may store comparison text CT received from the control circuit 131. In exemplary embodiments, comparator 134 may receive original text ORT from third buffer 132 and comparison text CT from fourth buffer 133. Comparator 134 may determine whether comparison text CT is the same as, or “equal to,” original text ORT and to generate a an appropriate value (e.g., enable or disabled) for alarm signal ALARM. For example, comparator 134 may generate disabled alarm signal ALARM (meaning processed text has integrity) when comparison text CT is the same as original text ORT, and generate enabled alarm signal ALARM (meaning processed text lacks integrity) when comparison text CT is not the same as original text ORT.

In exemplary embodiments in accordance with inventive concepts, verification unit 130a may receive input text IT from an external device, store input text IT as original text ORT, output first result text RT1 received from encryption/decryption unit 120 as output text OT, and provide first result text RT1 to control unit 110 as inner text INT in a first operational mode. In a second operational mode, verification unit 130a may receive second result text RT2 from encryption/decryption unit 120, store second result text RT2 as comparison text CT, generate an appropriate value for alarm signal ALARM by comparing original text ORT with comparison text CT, and output an alarm signal ALARM having the appropriate value in a second operational mode.

In accordance with exemplary embodiments of inventive concepts, if an original input command CMD from an external circuit indicates that input text is to be encrypted, first result text RT1, which is provided to the verification unit 130a in a first operational mode, may be an encrypted version of input text IT, and second result text RT2, which is provided to the verification unit 130a in a second operational mode, may be a decrypted version of first result text RT1. And, if an original input command CMD from an external circuit indicates that input text is to be decrypted, first result text RT1, which is provided to verification unit 130a in a first operational mode, may be a decrypted version of the input text IT, and the second result text RT2, which is provided to the verification unit 130a in a second operational mode, may be an encrypted version of first result text RT1. As a result, verification unit 130a may determine whether output text OT has integrity or not by comparing original text ORT, which is equal to input text IT, with comparison text CT, which is equal to second result text RT2, to generate an appropriate value for alarm signal ALARM.

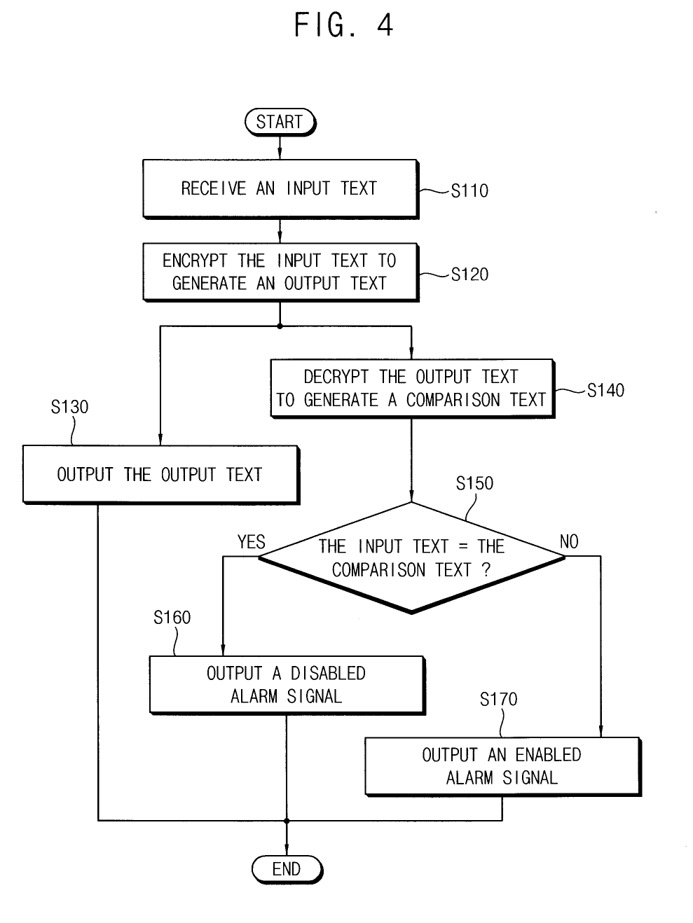

The flow chart of FIG. 4 will be used as an aid in describing the operation of an exemplary embodiment of an encryption operation such as may be carried out by an encryption/decryption device in accordance with principles of inventive concepts. In an exemplary embodiment an encryption/decryption device 100 employees a verification unit such as verification unit 130a described in the discussion related to FIG. 3.

A process in accordance with inventive concepts may begin in START and proceed from there to step S110, where control unit 110 receives input text IT and command signal CMD from an external device. Control unit 110 stores input text IT and command signal CMD, and provides input text IT and command signal CMD to encryption/decryption unit 120 as first start text ST1 and first encryption/decryption control signal CONED1, respectively. Input text IT may be plain text that is not encrypted, for example, and command signal CMD may be in a first logic level, which may be a logic high level, for example.

In step S120, encryption-decryption unit 120 encrypts first start text ST1 received from control unit 110 to generate first result text RT1 since the first encryption/decryption control signal CONED1 is in a first logic level. First result text RT1 is output text OT.

From step S120 the process proceeds to step S130, where verification unit 130a outputs first result text RT1 received from the encryption/decryption unit 120 as the output text OT. Additionally, verification unit 130a provides first result text RT1, which is output text OT, to control unit 110 as inner text INT.

Control unit 110 provides inner text INT received from verification unit 130a to encryption/decryption unit 120 as second start text ST2, and provides second encryption/decryption control signal CONED2, which is an inverted version of first encryption/decryption control signal CONED1, to encryption/decryption unit 120.

Encryption-decryption unit 120 decrypts second start text ST2 received from control unit 110 to generate second result text RT2 since second encryption/decryption control signal CONED2 is in a second logic level, and verification unit 130a stores second result text RT2 received from encryption/decryption unit 120 as comparison text CT (step S140).

In step S150 verification unit 130a determines whether comparison text CT is the same as original text ORT. If comparison text CT is the same as original text ORT, verification unit 130a outputs a disabled alarm signal ALARM, indicating that the encryption process has been successful, in step S160. If comparison text CT is not the same as original text ORT, verification unit 130a outputs an enabled alarm signal ALARM, indicating that the encryption process has failed, in step S170.

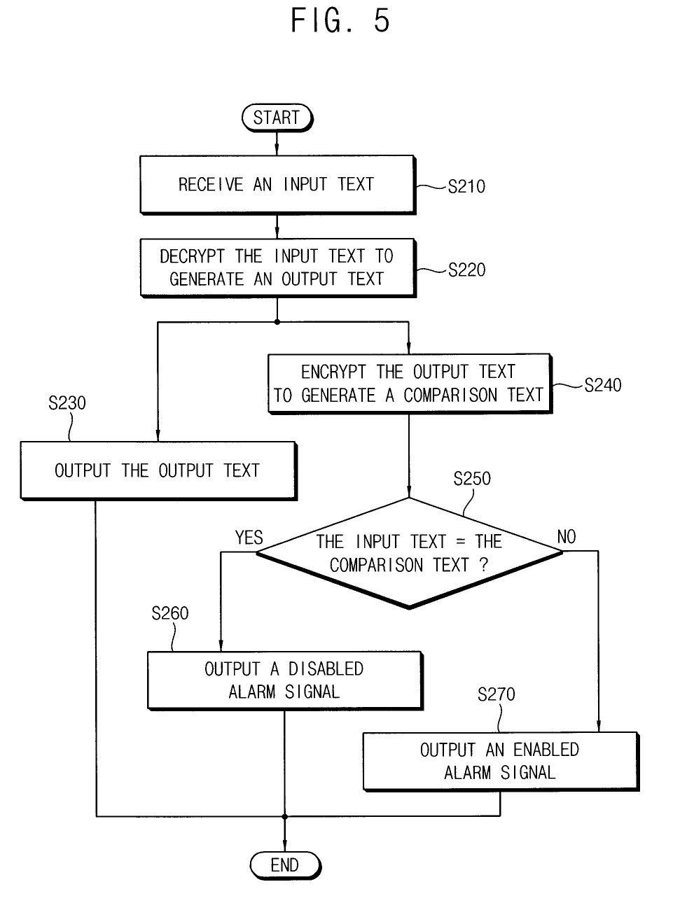

The flow chart of FIG. 5 will be used as an aid in describing the operation of an exemplary embodiment of a decryption operation such as may be carried out by an encryption/decryption device in accordance with principles of inventive concepts. In an exemplary embodiment and encryption device 100 employs a verification unit 130a such as described in the discussion related to FIG. 3.

A process in accordance with inventive principles starts and proceeds to step S210 where control unit 110 receives input text IT and command signal CMD from an external device. Control unit 110 stores input text IT and command signal CMD, and provides input text IT and command signal CMD to encryption/decryption unit 120 as first start text ST1 and first encryption/decryption control signal CONED1, respectively. Input text IT may be a text that is encrypted, and command signal CMD may be in a second logic level, which may be a logic level low.

In step S220 encryption/decryption unit 120 decrypts first start text ST1 received from control unit 110 to generate first result text RT1 since the first encryption/decryption control signal CONED1 is in a second logic level. In an exemplary embodiment, first result text RT1 is the same as output text OT.

In step S230 verification unit 130a outputs first result text RT1 received from encryption/decryption unit 120 as output text OT. In addition, verification unit 130a provides first result text RT1, which is the same as output text OT, to control unit 110 as inner text INT.

Control unit 110 provides inner text INT received from verification unit 130a to encryption/decryption unit 120 as second start text ST2, and provides second encryption/decryption control signal CONED2, which is an inverted version of the first encryption/decryption control signal CONED1, to encryption/decryption unit 120.

In step S240 encryption-decryption unit 120 encrypts second start text ST2 received from control unit 110 to generate second result text RT2 since second encryption/decryption control signal CONED2 is in a first logic level, and verification unit 130a stores second result text RT2 received from the encryption/decryption unit 120 as comparison text CT.

The process proceeds to step S250, where verification unit 130a determines whether the comparison text CT is the same as original text ORT. If comparison text CT is the same as original text ORT, verification unit 130a outputs a disabled value for alarm signal ALARM in step S260. If comparison text CT is not the same as original text ORT, verification unit 130a outputs an enabled value for alarm signal ALARM, indicating that an error has occurred in the decryption process, in step S270.

As described above, when encryption/decryption device 100 includes a verification unit such as exemplary unit 130a of FIG. 3, encryption/decryption device 100 may generate output text OT, which is either an encrypted version of input text IT or a decrypted version of input text IT according to the command signal CMD, and output output text OT at once in a first operational mode, and generate an appropriate value for alarm signal ALARM, which represents an integrity of the output text OT, by verifying the integrity of output text OT and output an appropriate value for alarm signal ALARM in a second operational mode. Therefore, an encryption/decryption device 100 in accordance with principles of inventive concepts may provide output text OT and an alarm signal ALARM representing the integrity of output text OT without requiring a separate device detect encryption/decryption interruption due, for example, to an attack from outside and without degrading the speed of the encryption/decryption process.

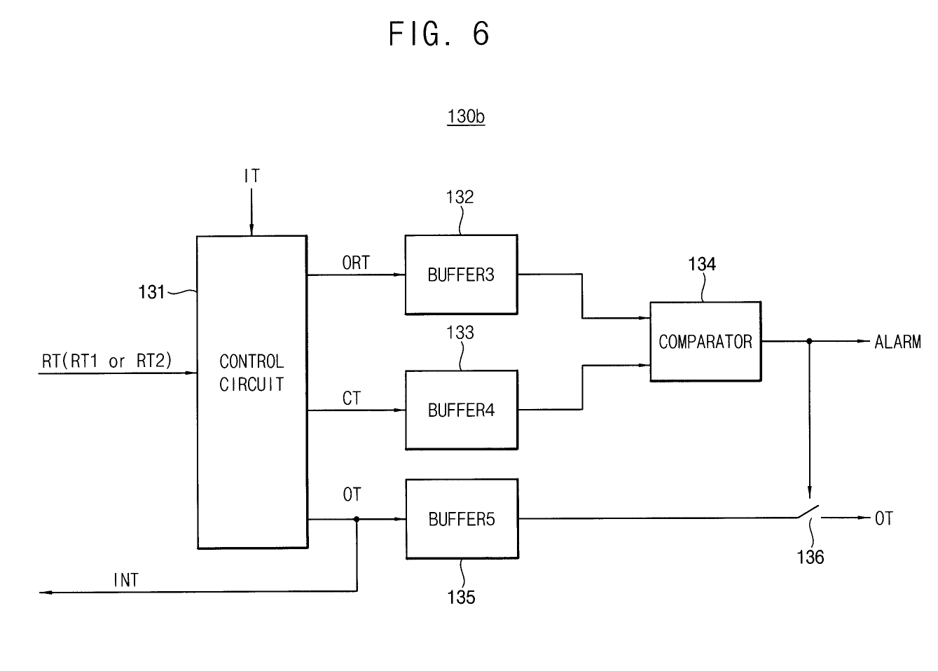

Another exemplary embodiment of a verification unit in accordance with principles of inventive concepts is depicted in FIG. 6. Verification unit 130b of FIG. 6 may generate output text OT and store output text OT in a first operational mode, and generate an appropriate value for alarm signal ALARM, and selectively output output text OT in response to a value of alarm signal ALARM in a second operational mode. That is, a verification unit 130b in accordance with principles of inventive concepts may delay transmission of preliminary operational results (that is, it may simply store encrypted/decrypted text) until it determines whether an encryption or decryption process has been successful (i.e., has integrity). Then, in a second operational mode, it may determine the integrity of the encrypted/decrypted text, update the status of alarm signal ALARM accordingly, and output text OT only if output text OT has integrity. In other words, verification unit 130b may not output first result text RT1, which is either an encrypted version of the input text IT or a decrypted version of the input text IT (depending upon command signal CMD), as output text OT upon a receipt of first result text RT1 from encryption/decryption unit 120, but store first result text RT1 as output text OT in a first operational mode. After that, in a second operational mode, verification unit 130b may generate an appropriate value for alarm signal ALARM by determining the integrity of output text OT, output alarm signal ALARM, and output output text OT only when output text OT has an integrity.

In an exemplary embodiment of inventive concepts of FIG. 6, verification unit 130b may include a control circuit 131, a third buffer 132, a fourth buffer 133, a comparator 134, a fifth buffer 135 and a switch 136.

Control circuit 131 may receive input text IT from an external device and provide input text IT to third buffer 132 as an original text ORT in a first operational mode. In addition, control circuit 131 may receive first result text RT1 from encryption/decryption unit 120, provide first result text RT1 to fifth buffer 135 as output text OT, and provide first result text RT1 to control unit 110 as inner text INT in a first operational mode. Control circuit 131 may receive second result text RT2 from encryption/decryption unit 120 and provide second result text RT2 to fourth buffer 133 as a comparison text CT in a second operational mode. As described above, input text IT is provided from an external device in a first operational mode. In an exemplary embodiment in accordance with inventive concepts, control circuit 131 may determine the operational mode of an encryption/decryption device based on whether or not input text IT is received from an external device.

In exemplary embodiments in accordance with inventive concepts, third buffer 132 may store original text ORT received from control circuit 131. Fourth buffer 133 may store comparison text CT received from control circuit 131. Fifth buffer 135 may store output text OT received from control circuit 131. Comparator 134 may receive original text ORT from third buffer 132 and comparison text CT from fourth buffer 133. Comparator 134 may determine whether comparison text CT is the same as original text ORT in order to determine an appropriate value for alarm signal ALARM. For example, comparator 134 may generate a disabled value for alarm signal ALARM when comparison text CT is the same as original text ORT, and generate an enabled value for alarm signal ALARM when comparison text CT is not the same as original text ORT. In some exemplary embodiments, enabled alarm signal ALARM may be in a logic high level, and disabled alarm signal ALARM may be in a logic low level, for example.

Switch 136 may be connected to fifth buffer 135 and be controlled to transmit or not transmit output text OT, according to the state of alarm signal ALARM. For example, the switch 136 may be “turned on,” or closed, (that is, in the output, or transmit state) when alarm signal ALARM is disabled (indicating that converted text has integrity, or, is correct), so that switch 136 outputs output text OT stored in fifth buffer 135. Switch 136 may be “turned off” or opened, (that is, in the do not output, or do not transmit state) when alarm signal ALARM is enabled (indicating that converted text does not have integrity, or, is incorrect), so that switch 136 does not output output text OT stored in the fifth buffer 135.

In operation, verification unit 130b may receive input text IT from an external device, store input text IT as original text ORT, store first result text RT1 received from encryption/decryption unit 120 as output text OT, and provide first result text RT1 to control unit 110 as inner text INT in a first operational mode. Verification unit 130b may receive second result text RT2 from encryption/decryption unit 120, store second result text RT2 as comparison text CT, generate an appropriate value for alarm signal ALARM by comparing the original text ORT with comparison text CT, output a value for signal ALARM, and selectively output (or not) output text OT according to a value of alarm signal ALARM in a second operational mode.

As described above, first result text RT1, which may be provided to verification unit 130b in a first operational mode, may be an encrypted version of the input text IT, and second result text RT2, which may be provided to verification unit 130b in a second operational mode, may be a decrypted version of first result text RT1. Alternatively, first result text RT1, which may be provided to a verification unit 130b in a first operational mode, may be a decrypted version of input text IT, and second result text RT2, which may be provided to verification unit 130b in a second operational mode, may be an encrypted version of first result text RT1. In an exemplary embodiment in accordance with inventive concepts, verification unit 130b may determine whether output text OT has integrity or not by comparing original text ORT, which is the same as input text IT, with comparison text CT, which is the same as second result text RT2, to generate an appropriate value for alarm signal ALARM. In addition, since verification unit 130b selectively outputs output text OT in response to a logic level of (that is, a value of) alarm signal ALARM, encryption/decryption device 100 may output output text OT only when output text OT has an integrity (that is, is correct), such that a reliability of encryption/decryption device 100 is increased.

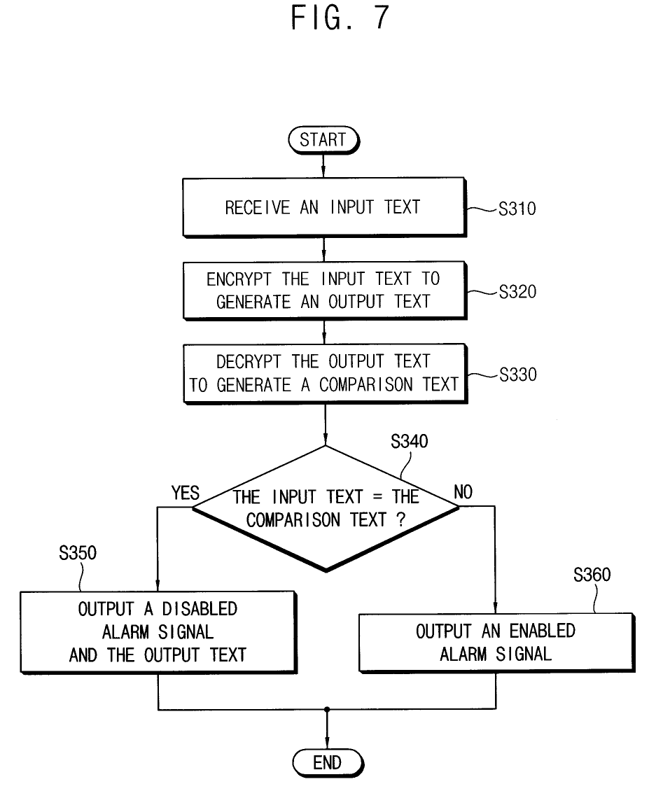

The flow chart of FIG. 7 will be used as an aid in describing an exemplary operation of an exemplary embodiment of an encryption process such as may be carried out by an encryption/decryption device 100 in accordance with inventive concepts. In an exemplary embodiment device 100 includes a verification unit such as verification unit 130b of FIG. 6. An exemplary process begins in START and proceeds to step S310 where control unit 110 receives input text IT and command signal CMD from an external device. Control unit 110 stores input text IT and command signal CMD, and provides input text IT and command signal CMD to encryption/decryption unit 120 as, respectively, first start text ST1 and first encryption/decryption control signal CONED1. Input text IT may be plain text (that is, text that is not encrypted) and command signal CMD may be in a first logic level, which may be a logic high level.

In step S320 encryption/decryption unit 120 encrypts first start text ST1 received from control unit 110 to generate first result text RT1 because first encryption/decryption control signal CONED1 is in a first logic level. First result text RT1 is the same as output text OT.

Verification unit 130b stores first result text RT1 received from encryption/decryption unit 120 as output text OT, and provides first result text RT1, which is the same as output text OT, to control unit 110 as inner text INT.

Control unit 110 provides inner text INT received from verification unit 130b to encryption/decryption unit 120 as second start text ST2, and provides second encryption/decryption control signal CONED2, which is an inverted version of first encryption/decryption control signal CONED1, to encryption/decryption unit 120.

In step S330 encryption/decryption unit 120 decrypts second start text ST2 received from control unit 110 to generate second result text RT2 because second encryption/decryption control signal CONED2 is in a second logic level, and verification unit 130b stores second result text RT2 received from encryption/decryption unit 120 as comparison text CT.

In step S340 verification unit 130b determines whether comparison text CT is the same as original text ORT. If comparison text CT is the same as original text ORT, verification unit 130b outputs disabled alarm signal ALARM (that is, updates the status of ALARM signal to indicate that the text conversion has been successful) and output text OT in step S350. If comparison text CT is not the same as original text ORT, verification unit 130b outputs the enabled alarm signal ALARM (that is, updates the status of ALARM signal to indicate that the text conversion has failed) in step S360.

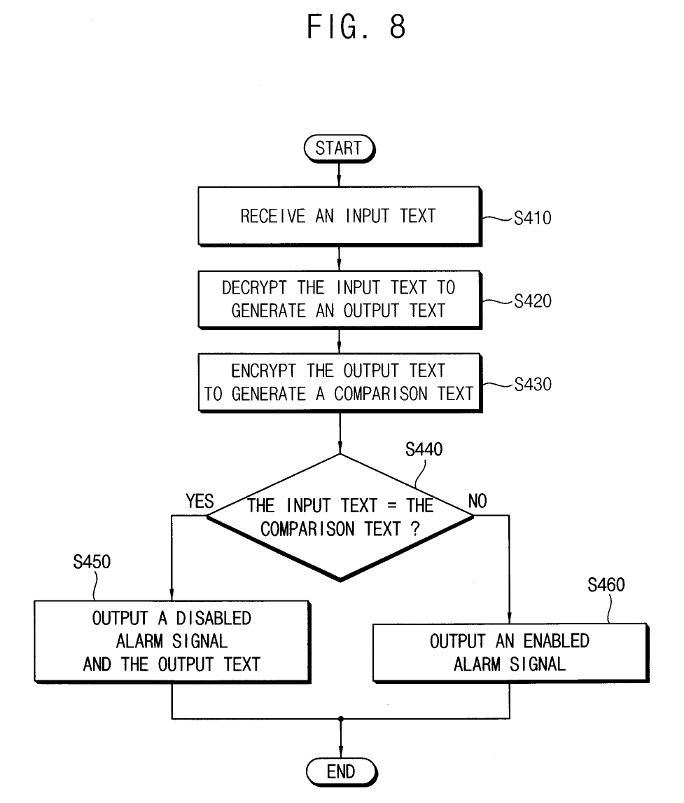

The flow chart of FIG. 8 will be used as an aid in describing the operation of an exemplary embodiment of an encryption operation such as may be performed by an encryption/decryption device in accordance with principles of inventive concepts. In an exemplary embodiment an encryption/decryption device 100 employs a verification unit 130b as described in the discussion related to FIG. 6.

An exemplary process begins in START and proceeds from there to step S410 where control unit 110 receives input text IT and command signal CMD from an external device. Control unit 110 stores input text IT and command signal CMD, and provides input text IT and command signal CMD to encryption/decryption unit 120 as, respectively, first start text ST1 and first encryption/decryption control signal CONED1. Input text IT may be text that is encrypted (e.g., cipher text), and command signal CMD may be in a second logic level, which may be a logic low level.

in step S420 encryption/decryption unit 120 decrypts first start text ST1 received from control unit 110 to generate first result text RT1 because first encryption/decryption control signal CONED1 is in a second logic level. First result text RT1 is the same as output text OT.

Verification unit 130b stores first result text RT1 received from encryption/decryption unit 120 as output text OT, and provides first result text RT1, which is the same as output text OT, to control unit 110 as the inner text INT.

Control unit 110 provides inner text INT received from verification unit 130b to encryption/decryption unit 120 as second start text ST2, and provides second encryption/decryption control signal CONED2, which is an inverted version of first encryption/decryption control signal CONED1, to encryption/decryption unit 120.

In step S430 encryption/decryption unit 120 encrypts second start text ST2 received from control unit 110 to generate second result text RT2 because second encryption/decryption control signal CONED2 is in a second logic level, and verification unit 130b stores second result text RT2 received from encryption/decryption unit 120 as comparison text CT.

In step S440 verification unit 130b determines whether comparison text CT is the same as original text ORT. If comparison text CT is the same as original text ORT, verification unit 130b outputs disabled alarm signal ALARM and output text OT in step S450. If comparison text CT is not the same as original text ORT, verification unit 130b outputs enabled alarm signal ALARM and does not output the output text OT in step S460.

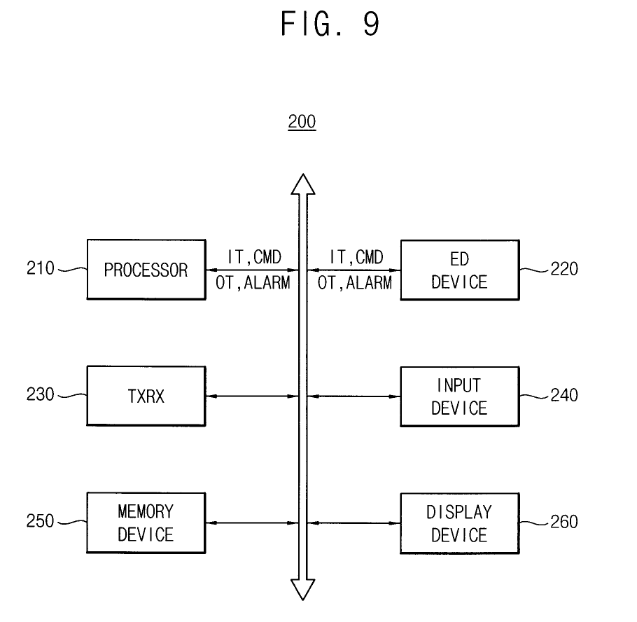

As described above, when the encryption/decryption device 100 includes an exemplary verification unit such as verification unit 130b of FIG. 6, encryption/decryption device 100 may generate output text OT, which is either an encrypted version of input text IT or a decrypted version of input text IT, according to the command signal CMD, and store output text OT in a first operational mode, and determine an appropriate value for alarm signal ALARM, which represents the integrity of output text OT, by verifying the integrity of output text OT, output the alarm signal ALARM, and output output text OT only when the output text OT has an integrity (that is, is accurate) in a second operational mode. In this manner, an encryption/decryption device 100 in accordance with inventive concepts may provide output text OT and alarm signal ALARM representing the integrity of output text OT without a separate device for detecting an attack from outside and without degrading the reliability of encryption/decryption device 100. A system 2000 such as that depicted in the block diagram of FIG. 9 may include an encryption/decryption device 220 in accordance with principles of inventive concepts. System 2000 includes a processor 210 which may control encryption/decryption device 220 by providing input text IT and command signal CMD to encryption/decryption device 220, for example.

In operation encryption/decryption device 220 may generate an output text OT by encrypting or decrypting input text IT according to command signal CMD. Encryption/decryption device also may generate an alarm signal ALARM that indicates the validity, or integrity, of output text OT. Encryption/decryption device 220 may provide output text OT and alarm signal ALARM to processor 210, for example. Encryption/decryption device 220 in accordance with principles of inventive concepts includes a control unit, an encryption/decryption unit and a verification unit.

In an exemplary embodiment, control unit receives command signal CMD and input text IT from processor 210. The control unit generates a start text and an encryption/decryption control signal in response to command signal CMD and one of input text IT and an inner text according to an operational mode. In an exemplary embodiment, inner text is provided from verification unit. Encryption/decryption unit receives start text and an encryption/decryption control signal from control unit. Encryption/decryption unit either encrypts or decrypts start text to generate a result text in response to an encryption/decryption control signal. Verification unit receives input text IT from processor 210 and result text from encryption/decryption unit. Verification unit provides result text to control unit as inner text and generates output text OT and alarm signal ALARM based on result text and input text IT according to an operational mode of encryption/decryption device 220. For example, verification unit may generate a disabled alarm signal ALARM when output text OT has an integrity (that is, is accurate), and generate an enabled alarm signal ALARM when output text OT does not have an integrity (that is, has errors).

Encryption/decryption device 220 of FIG. 9 may be as described in exemplary embodiments of encryption/decryption device 100 of FIG. 1. Because exemplary structures and operation of encryption/decryption device 100 of FIG. 1 are described above with reference to FIGS. 1 to 8 a detail description of encryption/decryption device 220 of FIG. 9 will not be revisited.

Processor 210 may provide a plain text, which is not an encrypted text, to the encryption/decryption device 220 as the input text IT, and provide command signal CMD having a first logic level to encryption/decryption device 220, inducing encryption/decryption device 220 to generate output text OT by encrypting input text IT and to generate an appropriate value for alarm signal ALARM by determining the integrity of output text OT. Alternatively, processor 210 may provide encrypted text a cipher text to encryption/decryption device 220 as input text IT, and provide command signal CMD having a second logic level to encryption/decryption device 220, inducing encryption/decryption device 220 to generate output text OT by decrypting input text IT and to generate an appropriate value for alarm signal ALARM by determining the integrity of output text OT.

Processor 210 may stop an operation of the encryption/decryption device 220 based on a value of alarm signal ALARM. For example, processor 210, when encryption/decryption device 220 sets alarm signal ALARM to a value that reflects a conversion error (that is, an encryption or decryption error), processor 210 may stop operation of encryption/decryption device 220.

System 200 may further include a transmission/reception device 230, an input device 240, a memory device 250 and a display device 260. Although not illustrated in FIG. 9, system 200 may further include ports to communicate with a video card, a sound card, a memory card, a universal serial bus (USB) device, etc.

Transmission/reception device 230 may receive input text IT from an external device and provide input text IT to processor 210. Processor 210 may provide input text IT received from transmission/reception device 230 to encryption/decryption device 220 and provide output text OT received from encryption/decryption device 220 to transmission/reception device 230, for example. Transmission/reception device 230 may transmit output text OT received from encryption/decryption device 220 to an external device.

Input device 240 may include a keyboard, a mouse, speech input device, etc. Input device 240 may receive input text IT from a user and provide input text IT to processor 210. Processor 210 may provide input text IT received from input device 240 to encryption/decryption device 220.

Memory device 250, which may be a volatile memory such as a dynamic random access memory (DRAM), a static random access memory (SRAM), etc, or a non-volatile memory such as a hard disk drive (HDD), a compact disk drive (CD), a solid state drive (SSD), a flash memory, etc, may store output text OT.

Display device 260 may display output text OT. When processor 210 receives an enabled alarm signal ALARM from encryption/decryption device 220, processor 210 may control display device 260 so that display device 260 displays an alarm message to report an attack from outside, or, simply, a conversion (encryption/decryption) error, for example.

Processor 210 may perform various computing functions, such as executing specific software for performing specific calculations or tasks. For example, processor 210 may be a microprocessor or a central process unit. Processor 210 may be connected to encryption/decryption device 220, transmission/reception device 230, input device 240, memory device 250, and display device 260 via bus such as an address bus, a control bus or a data bus, etc. Processor 210 may be connected to an extended bus, such as peripheral component interconnect (PCI) bus, for example.

Processor 210 may be embodied as a single core architecture or a multi core architecture. For example, processor 210 may be embodied as a single core architecture when an operating frequency of the processor 210 is less than 1 GHz, and processor 210 may be embodied as a multi core architecture when an operating frequency of processor 210 is greater than 1 GHz. A processor 210 that is embodied as a multi core architecture may communicate with peripheral devices via an advanced extensible interface (AXI) bus.

System 200 may be a mobile device, a smart phone, a cellular phone, a desktop computer, a laptop computer, a work station, a handheld device, or the like.

As described above, an encryption/decryption device and a system according to exemplary embodiments may provide output text and an alarm signal indicating the integrity of output text without a separate device for detecting an attack from outside.

The foregoing is illustrative of the present inventive concept and is not to be construed as limiting thereof. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. An encryption/decryption device, comprising:
a control unit configured to generate a start text and an encryption/decryption control signal in response to a command signal and one of an input text and an inner text according to an operational mode;
an encryption/decryption unit configured to encrypt or decrypt the start text to generate a result text in response to the encryption/decryption control signal; and
a verification unit configured to provide the result text to the control unit as the inner text and generate an output text and an alarm signal based on the result text and the input text according to the operational mode, the output text being an encrypted version of the input text or a decrypted version of the input text, the alarm signal representing an integrity of the output text.

2. The encryption/decryption device of claim 1, wherein the verification unit generates the output text in a first operational mode, and generates the alarm signal by verifying the integrity of the output text in a second operational mode.

3. The encryption/decryption device of claim 2, wherein the control unit generates a first start text and a first encryption/decryption control signal in response to the command signal and the input text in the first operational mode, and generates a second start text and a second encryption/decryption control signal in response to the command signal and the inner text in the second operational mode.

4. The encryption/decryption device of claim 3, wherein the control unit outputs the input text as the first start text in the first operational mode, and outputs the inner text as the second start text in the second operational mode.

5. The encryption/decryption device of claim 3, wherein the second encryption/decryption control signal is an inverted version of the first encryption/decryption control signal.

6. The encryption/decryption device of claim 2, wherein the control unit includes:
a first buffer configured to receive the input text and output the input text as a first start text in the first operational mode, and configured to receive the inner text and output the inner text as a second start text in the second operational mode;
a second buffer configured to receive the command signal in the first operational mode, and configured to output the command signal as a first encryption/decryption control signal in the first operational mode and in the second operational mode;
an inverter configured to invert the first encryption/decryption control signal to generate a second encryption/decryption control signal;
a control circuit configured to generate an inner control signal having a first logic level when the input text is received, and configured to generate the inner control signal having a second logic level when the inner text is received; and
a multiplexer configured to output one of the first encryption/decryption control signal and the second encryption/decryption control signal in response to a logic level of the inner control signal.

7. The encryption/decryption device of claim 2, wherein the encryption/decryption unit either encrypts the start text to generate a first result text in the first operational mode and decrypts the start text to generate a second result text in the second operational mode, or decrypts the start text to generate the first result text in the first operational mode and encrypts the start text to generate the second result text in the second operational mode, in response to a logic level of the encryption/decryption control signal.

8. The encryption/decryption device of claim 2, wherein the verification unit generates the output text and outputs the output text in the first operational mode, and generates the alarm signal and outputs the alarm signal in the second operational mode.

9. The encryption/decryption device of claim 2, wherein the verification unit receives the input text, stores the input text as an original text, outputs the result text received from the encryption/decryption unit as the output text, and provides the result text to the control unit as the inner text in the first operational mode, and stores the result text as a comparison text, generates the alarm signal by comparing the original text with the comparison text, and outputs the alarm signal in the second operational mode.

10. The encryption/decryption device of claim 2, wherein the verification unit includes:
a control circuit configured to receive the input text, output the input text as an original text, output the result text received from the encryption/decryption unit as the output text, and provide the result text to the control unit as the inner text in the first operational mode, and configured to output the result text as a comparison text in the second operational mode;
a first buffer configured to store the original text received from the control circuit;
a second buffer configured to store the comparison text received from the control circuit; and
a comparator configured to generate the signal based on whether the comparison text stored in the second buffer is equal to the original text stored in the first buffer.

11. The encryption/decryption device of claim 2, wherein the verification unit generates the output text and stores the output text in the first operational mode, and generates the alarm signal, outputs the alarm signal, and selectively outputs the output text in response to a logic level of the alarm signal in the second operational mode.

12. The encryption/decryption device of claim 2, wherein the verification unit receives the input text, stores the input text as an original text, stores the result text received from the encryption/decryption unit as the output text, and provides the result text to the control unit as the inner text in the first operational mode, and stores the result text as a comparison text, generates the alarm signal by comparing the original text with the comparison text, outputs the alarm signal, and selectively outputs the output text in response to a logic level of the alarm signal in the second operational mode.

13. The encryption/decryption device of claim 2, wherein the verification unit includes:
a control circuit configured to receive the input text, output the input text as an original text, output the result text received from the encryption/decryption unit as the output text, and provide the result text to the control unit as the inner text in the first operational mode, and configured to output the result text as a comparison text in the second operational mode;
a first buffer configured to store the original text received from the control circuit;
a second buffer configured to store the comparison text received from the control circuit;
a third buffer configured to store the output text received from the control circuit;
a comparator configured to generate the alarm signal based on whether the comparison text stored in the second buffer is equal to the original text stored in the first buffer; and
a switch configured to selectively output the output text stored in the third buffer in response to a logic level of the alarm signal.

14. A system, comprising:
an encryption/decryption device configured to generate an output text by encrypting or decrypting an input text in response to a command signal and generate an signal representing an integrity of the output text; and
a processor configured to control the encryption/decryption device by providing the input text and the command signal to the encryption/decryption device,
wherein the encryption/decryption device includes:
a control unit configured to generate a start text and an encryption/decryption control signal in response to the command signal and one of the input text and an inner text according to an operational mode;
an encryption/decryption unit configured to encrypt or decrypt the start text to generate a result text in response to the encryption/decryption control signal; and
a verification unit configured to provide the result text to the control unit as the inner text and generate the output text and the alarm signal based on the result text and the input text according to the operational mode.

15. The system of claim 14, wherein the processor stops an operation of the encryption/decryption device based on the alarm signal.

16. A method in an encryption/decryption device, comprising:
cryptographically processing input data from a first source to produce output data;
inverse-cryptographically processing input data from a second source to produce comparison data, wherein input data from a second source is output data from a first cryptographic process;
comparing input data from the first source to comparison data and setting the value of an alarm based on the results of the comparison.

17. The method of claim 16, wherein the cryptographic process is an encryption process and the inverse-cryptographic process is a decryption process.

18. The method of claim 16, wherein the cryptographic process is a decryption process and the inverse-cryptographic process is an encryption process.

19. The method of claim 16, wherein output data is transmitted external to the encryption/decryption device at the same time or before the value of the alarm is determined.

20. The method of claim 16, wherein, if the comparison determines that input data from the first source and comparison data are the same, output data is transmitted outside the encryption/decryption device and the alarm is set to a value indicating that the cryptographic process was successful; and, if the comparison determines that input data from the first source and comparison data are not the same, output data is not transmitted outside the encryption/decryption device and the alarm is set to a value indicating that the cryptographic process was unsuccessful.
